(19) United States
(12) Patent Application Publication
(10) Pub. No.: US 2005/0231654 A1
(43) Pub. Date: Oct. 20, 2005

(54) Projection device having an increased efficiency

(75) Inventors: Henricus Marinus Josephus Hikspoors, Eindhoven (NL); Willem Hendrik Smits, Eindhoven (NL); Adrianus Johannes Stephanes Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/506,287

(22) PCT Filed: Feb. 12, 2003
(86) PCT No.: PCT/IB03/00484

§ 371 Date: Aug. 31, 2004

(30) Foreign Application Priority Data
Mar. 6, 2002 (EP) 02075863.7

(51) Int. Cl. G02F 1/1335

(52) U.S. Cl. 349/5

(57) ABSTRACT

The invention relates to a projection device for projecting an image, comprising a light source (1), a LCD projection subsystem (3) and a projection means (4, 5) for projecting the image. A small-sized and low-cost projection device is porposed wherein said projection subsystem comprises: a waveguide integrator (30) for guiding light from an entrance (31) to an exit (34), the inner entrance surface (33) of said integrator (30) being coated with a reflective material and having a hole (32) for coupling light emitted from said light source (1) into said integrator (30), a reflective polarizer (35) provided at the exit surface (34) of said integrator (30) for reflecting light having the wrong polarization backinto said integrator (30), a transmissive LCD (36) provided at the exit of said reflective polarizer (35) for modulating the light transmitted by said polarizer (35), said LCD (36) having an integrated reflective color filter array (37) for reflecting light having the wrong color back into said integrator (30).

The invention relates to a projection device for projecting an image comprising a light source, a transmissive LCD projection subsystem and a projection means for projecting the image. The invention also relates to a corresponding method of projecting an image and to a transmissive LCD projection device.

A projection device of this type is disclosed in U.S. Pat. No. 5,889,567. According to one embodiment, the display system includes a parabolic light source and a condenser lens to focus the light from the light source through an aperture of a light pipe assembly. The light pipe terminates at an abutting phase plate. The image plane of a LCD panel is separated from the image plane of the phase plate by a distance. A projection lens projects the image formed on the display panel onto a viewing surface. The light pipe assembly 330 includes four reflective surfaces which cooperate to create a light guide or pipe which is dimensioned so as to evenly mix the light from the aperture before the light reaches the phase plate. It is preferably a rod having a rectangular cross-section and fabricated from optical glass with reflective surfaces on the peripheral surface of the rod. The phase plate separates the impinging light into red, green and blue wavelength components and directs these wavelength components onto respective sub-pixels of the LCD panel. By driving the LCD panel with control circuitry, the sub-pixels can be valved so as to generate a colour image across the face of the display panel.

It is the object of the present invention to provide an improved projection device which has a higher efficiency of utilisation of light and can be built smaller and cheaper.

According to the present invention, this object is achieved by providing a projection subsystem in the projection device, the projection subsystems comprising:
a waveguide integrator for guiding light from an entrance to an exit, the inner entrance surface of said integrator being coated with a reflective material and having a hole for coupling light emitted from said light source into said integrator,
a reflective polarizer provided at the exit surface of said integrator for reflecting light having the wrong polarization back into said integrator,
a transmissive LCD provided at the exit of said reflective polarizer for modulating the light transmitted by said polarizer, said LCD having an integrated reflective color filter array for reflecting light having the wrong color back into said integrator.

The invention is based on the idea to reflect as much as possible light which cannot be used effectively back into the waveguide integrator or inside the waveguide integrator itself so as to improve utilisation of light. Furthermore, by integrating certain elements of the projection subsystem, a very small and low-cost projection device can be built. The projection subsystem according to the present invention uses a waveguide integrator of the type as described in U.S. Pat. No. 5,146,248 or U.S. Pat. No. 5,889,567, particularly with reference to FIG. 19, the description of which document is herein incorporated by reference. The waveguide integrator according to the invention has an exit window that is coupled to a transmissive LCD with an integrated reflected colour filter array. A reflective polarizer is placed between the exit window and the LCD. The polarizer reflects light having the wrong polarization back into the integrator, while the reflective colour filter array reflects light having the wrong colour back into the integrator. Since a mirror is located at the entrance surface of the integrator, having only a small hole in it to allow the light from the projection lamp to enter the integrator, most of the light that is bounced back in the integrator hits the mirror, is recycled and gets a new opportunity to pass the display and hit the screen. Thus, a high efficiency of light utilization can be achieved.

Preferred embodiments of the invention are defined in the dependent claims. A corresponding method of projecting an image according to the invention is defined in claim 10. A transmissive LCD projection device for use in a projection device as claimed in claim 1 is defined in claim 9. Most of the light reflected into the waveguide integrator will then be redirected to the LCD at the reflective entrance surface of the waveguide.

It is preferred that the reflective colour filter array comprises a dichroic mirror or a polymer layer. However, any other reflective colour filter means may also be used. Normally, such types of color LCDs have a color filter pattern using absorption-type filter elements. These absorption-type filter elements absorb the light with the wrong spectral characteristics. Since the light is absorbed, it is lost and cannot be recycled. Subsequently, this absorption generates heat and thus limits the allowed light density on the panel (due to life time restrictions of the system), and this limits the maximum brightness. Using reflective color filters enables the light to be recycled and allows a higher lightflux through the panel.

To obtain a very small-sized projection device, the reflective colour filter array is preferably located at the inner surface of one of the substrates of said LCD, i.e. close to the pixel structure in the LCD panel, for example, at the inside of the glass carrier plate of which the display is made, and is situated between the polarizer and the LCD. The LCD panel comprises an LC layer sandwiched between two glass substrates. Each substrate has a thickness of approx. 0.5 or more mm. Having the filter pattern at the outside surface of the display would mean that there is a distance of more than 0.5 mm between the filter pattern and the pixel structure. This would cause parallax problems and limit the numerical aperture of the system so that hardly any light can pass the system. It should be noted that typical pixel dimensions are in the range of 5 to 20 microns.

In order to maintain a 4:3 or 16:9 aspect ratio, the reflective colour filter array preferably comprises a number of colour stripes having a 3:1 aspect ratio.

For changing the polarization of light reflected back into the integrator, retardation films are preferably provided at the exit side of the integrator.

In order to further increase efficiency of light utilisation, the exit surface of the LCD outside the visible window is made reflective so that light will also be reflected back into the waveguide integrator from these parts of the LCD.

Depending on the type of application, the colour filter array preferably either has an orthogonal or a diagonal configuration, the orthogonal configuration being preferred for data projection and the diagonal configuration being preferred for video projection.

Preferably, the integrator is made of a higher refractive index material so that the light that hits the side walls during traversing from the entrance surface to the exit surface is bounced back into the integrator by critical angle reflections.

The invention will now be explained in more detail with reference to the drawings in which

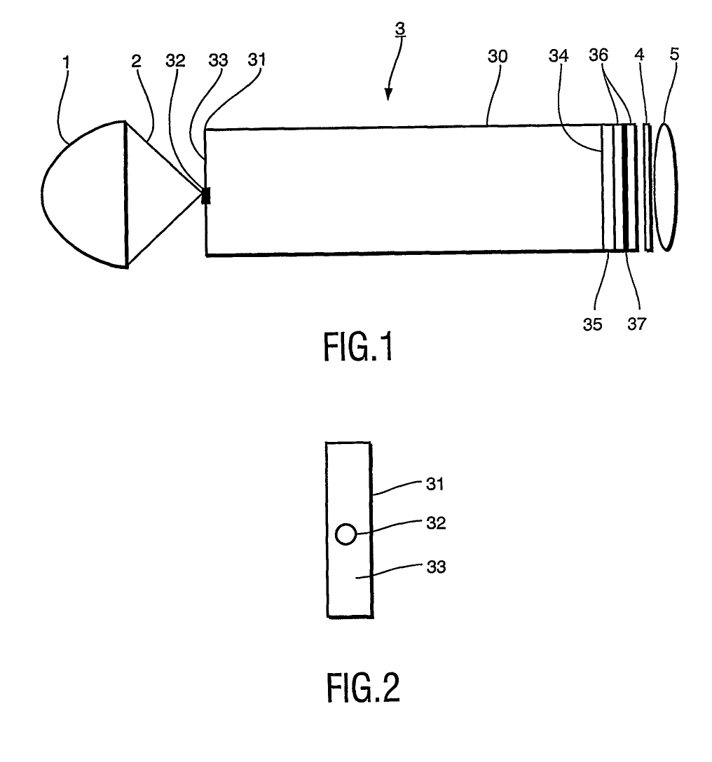

FIG. 1 shows an embodiment of a projection device according to the present invention,

FIG. 2 shows the entrance surface of the waveguide integrator and

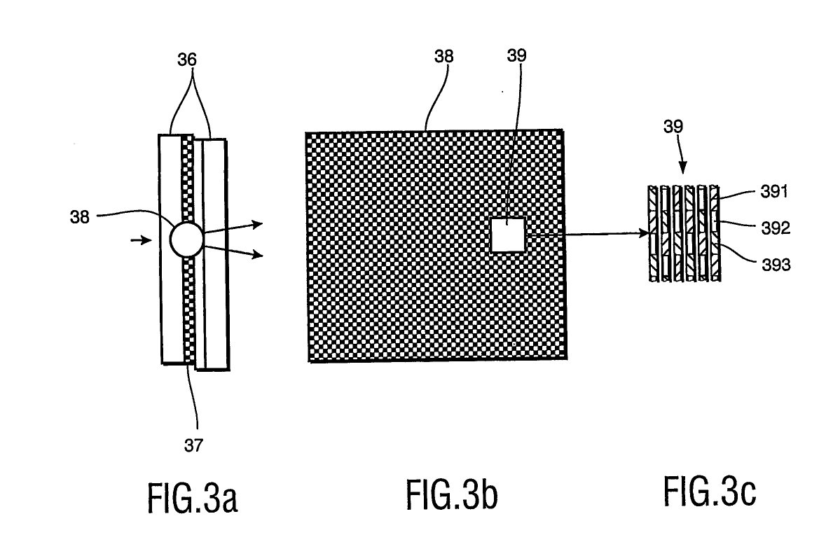

FIG. 3 shows an LCD with an integrated reflective colour filter array.

A projection device according to the present invention is shown in FIG. 1. It comprises a light source 1, such as a projection lamp having an elliptical reflector, for emitting a light beam 2, a projection subsystem 3, an analyser 4 and a projection lens 5 for projecting an image onto a screen or a wall. The projection subsystem 3 comprises a waveguide integrator using a waveplate as rod integrator having the entrance surface 31 coated with a reflecting material 33 such as a mirror. The light 2 from the projection lamp 1 is coupled into the waveguide integrator 30 via a small hole 32 in the mirror 33 at the entrance surface 31. The exit surface 34 of the waveguide integrator 30 is coupled to a transmissive liquid crystal display (LCD) 36 via a reflective polarizer 35. The LCD 36 further comprises an integrated reflected colour filter array 37.

The reflective polarizer 35 reflects light with the wrong polarization back into the waveguide integrator 30. Light of the wrong colour is reflected by the colour filter array 37 and will be redistributed inside the waveguide integrator 30. The polarization of the reflected light can be changed either by retardation films or by birefringence inside the waveguide integrator 30. It will then be reflected by the reflective mirror 33 at the entrance surface 31 back to the LCD 36. Thus, a highly efficient system using as much as possible light is obtained. Furthermore, since only a few optical components of a small size are required and the waveguide integrator 30 itself can be of low cost, the invention allows building an extremely small and low-cost projection device.

Apart from reflecting light having the wrong colour back into the waveguide wavelength components and directs these wavelength components onto respective sub-pixels of the LCD panel 36. By driving the LCD 36 with control circuitry (not shown), the sub-pixels can be valved so as to generate a colour image across the face of the LCD 36.

The waveguide integrator 30 includes reflective surfaces which cooperate to create a light guide or pipe. The light pipe is dimensioned so as to evenly mix the light from the entrance hole 32 before the light reaches the reflective polarizer 35. Preferably, the waveguide integrator 30 is sufficiently birefringent to obtain polarization conversion inside it. On the exit side 34, an additional retardation film can be positioned to improve the polarization conversion. The length of the waveguide integrator 30 can be designed so as to guarantee an optimal integration function.

The entrance surface 31 of the waveguide integrator 30 is shown in another perspective view in FIG. 2. In this Figure, the hole 32 in the centre of the entrance plate 31 can be clearly seen. The remaining surface 33 of the entrance plate 31 is coated with a reflective mirror layer so as to reflect light inside the waveguide integrator 30.

The LCD 36 together with the integrated reflective colour filter array 37 is shown in more detail in FIG. 3. FIG. 3a shows a cross-section through the LCD panel 36 comprising two layers between which the reflective colour filter array 37 is located. An enlarged portion 38 of said array 37 is shown in FIG. 3b. Even more details can be recognized in FIG. 3c showing an enlarged portion 39. It can be seen in this Figure that the filter array comprises colour stripes 391, 392, 393 of three different colours having a 3:1 aspect ratio to maintain the 4:3 or 16:9 aspect ratio. Furthermore, the filter array may have an orthogonal or a diagonal configuration, diagonal being preferred for video, orthogonal for data.

The present invention requires an LCD with a reflective colour filter array. However, since only one LCD is required, the LCD can be larger than in a three-panel system. In summary, a small-sized and low-cost projection device can be built, preferably of the transmissive type having only a single panel LCD.

1. A projection device for projecting an image comprising a light source for emitting light, a transmissive LCD projection subsystem and a projection means for projecting the image, said projection subsystem comprising:
a waveguide integrator for guiding light from an entrance to an exit, the inner entrance surface of said integrator being coated with a reflective material and having a hole for coupling light emitted from said light source into said integrator,
a reflective polarizer provided at the exit surface of said integrator for reflecting light having the wrong polarization back into said integrator,
a transmissive LCD provided at the exit of said reflective polarizer for modulating the light transmitted by said polarizer, said LCD having an integrated reflective color filter array for reflecting light having the wrong color back into said integrator.

2. A projection device as claimed in claim 1, wherein said reflective color filter array comprises a dichroic mirror or a polymer layer.

3. A projection device as claimed in claim 1, wherein said reflective color filter array is located at the inner surface of one of the substrates of said LCD and between said polarizer and said LCD.

4. A projection device as claimed in claim 1, wherein said reflective color filter array comprises a number of color stripes having a 3:1 aspect ratio.

5. A projection device as claimed in claim 1, wherein said waveguide integrator further comprises retardation films for changing the polarization of light reflected back into the integrator.

6. A projection device as claimed in claim 1, wherein the surface of the LCD outside the visible window is made reflective.

7. A projection device as claimed in claim 1, wherein said reflective colour filter array has an orthogonal or a diagonal configuration.

8. A projection device as claimed in claim 1, wherein said integrator is made of a higher refractive index material for reflecting light.

9. A transmissive LCD projection device for use in a projection device for projecting an image as claimed in claim 1, comprising a light source for emitting light and a projection means, said projection device comprising:
a waveguide integrator for guiding light from an entrance to an exit, the inner entrance surface of said integrator being coated with a reflective material and having a hole for coupling light emitted from said light source into said integrator,
a reflective polarizer provided at the exit surface of said integrator for reflecting light having the wrong polarization back into said integrator,
a transmissive LCD provided at the exit of said reflective polarizer for modulating the light transmitted by said polarizer, said LCD having an integrated reflective color filter array for reflecting light having the wrong color back into said integrator.

10. A method of projecting an image, the method comprising the steps of:
emitting light using a light source,
guiding light received from said light source at an entrance to an exit, using a waveguide integrator, the inner entrance surface of said integrator being coated with a reflective material and having a hole for coupling light emitted from said light source into said integrator,
reflecting light having the wrong polarization back into said integrator, using a reflective polarizer provided at the exit surface of said integrator,
modulating the light transmitted by said polarizer, using a transmissive LCD provided at the exit of said reflective polarizer, said LCD having an integrated reflective color filter array for reflecting light having the wrong color back into said integrator.
